(19) United States
(12) Patent Application Publication
(10) Pub. No.: US 2015/0054481 A1
(43) Pub. Date: Feb. 26, 2015

(54) SWITCH CIRCUIT

(71) Applicant: KABUSHIKI KAISHA TOSHIBA, TOKYO (JP)

(72) Inventor: Yusuke Hikichi, Kanagawa-ken (JP)

(73) Assignee: KABUSHIKI KAISHA TOSHIBA, TOKYO (JP)

(21) Appl. No.: 14/140,283

(22) Filed: Dec. 24, 2013

(30) Foreign Application Priority Data
Aug. 22, 2013 (JP) 2013-171807

(51) Int. Cl. H02M 3/157

(52) U.S. Cl. CPC H02M 3/157
USPC 323/283

(57) ABSTRACT

According to an embodiment, a switch circuit includes an output transistor, a charge pump circuit, and a high pass filter. The output transistor includes a first end to which an input voltage is input, a second end from which an output voltage is output, and a control terminal. The charge pump circuit receives a first clock signal based on both of a reference clock signal and a first signal, and outputs a charge pump voltage to the control terminal of the output transistor, the first signal is based on the charge pump voltage. The high pass filter includes a first end receiving the charge pump voltage and a second end to which a ground voltage is applied, and generates a second signal.

### CROSS REFERENCE TO RELATED APPLICATION

This application is based upon and claims the benefit of priority from the prior Japanese Patent Application No. 2013-171807, filed on Aug. 22, 2013, the entire contents of which are incorporated herein by reference.

### FIELD

Embodiments described herein relate to a switch circuit.

### BACKGROUND

Generally, a switch circuit is used for a power supply line to control power supply from a power management integrated circuit to the subsequent stage. In a case in which the switch circuit has a large output load capacitance, during the ON period, a large rush current flows as a charging current. The rush current causes the power management integrated circuit to malfunction or causes the wire line or the like to exceed a current allowable value, so that the rush current leads to destruction of the power management integrated circuit or the wire line.

In general, a switch circuit includes a soft start circuit to suppress the rush current. However, in a case in which the soft start circuit is installed, the size of the switch circuit is increased, and thus, there are problems in that the occupation area and the current consumption are increased.

### BRIEF DESCRIPTION OF THE DRAWINGS

FIG. 1 is a circuit diagram illustrating a switch circuit according to a first embodiment;

FIG. 2 is a circuit diagram illustrating a switch circuit according a comparative example of the first embodiment;

FIG. 3 is circuit diagram illustrating a basic charge pump cell constituting a charge pump circuit according to the first embodiment;

FIG. 4 is a circuit diagram illustrating a charge pump circuit having a separate configuration according to the first embodiment;

FIG. 5 is a timing chart illustrating operations of the switch circuit according to the first embodiment;

FIG. 6 is a diagram illustrating a rush current occurring in the switch circuit according to the first embodiment;

FIG. 7 is a diagram illustrating a rush current occurring in the switch circuit which does not perform a soft start operation according to the first embodiment;

FIG. 8 is a circuit diagram illustrating a switch circuit according to a second embodiment; and

FIG. 9 is a circuit diagram illustrating a switch circuit according to a first modification.

### DETAILED DESCRIPTION

According to an embodiment, a switch circuit includes an output transistor, a charge pump circuit, and a high pass filter. The output transistor includes a first end to which an input voltage is input, a second end from which an output voltage is output, and a control terminal. The charge pump circuit receives a first clock signal based on both of a reference clock signal and a first signal, and outputs a charge pump voltage to the control terminal of the output transistor, the first signal is based on the charge pump voltage. The high pass filter includes a first end receiving the charge pump voltage and a second end to which a ground voltage is applied, and generates a second signal.

Hereinafter, a plurality of embodiments will be described with reference to the accompanying drawings. In the drawings, the same or similar components are denoted by the same reference numerals.

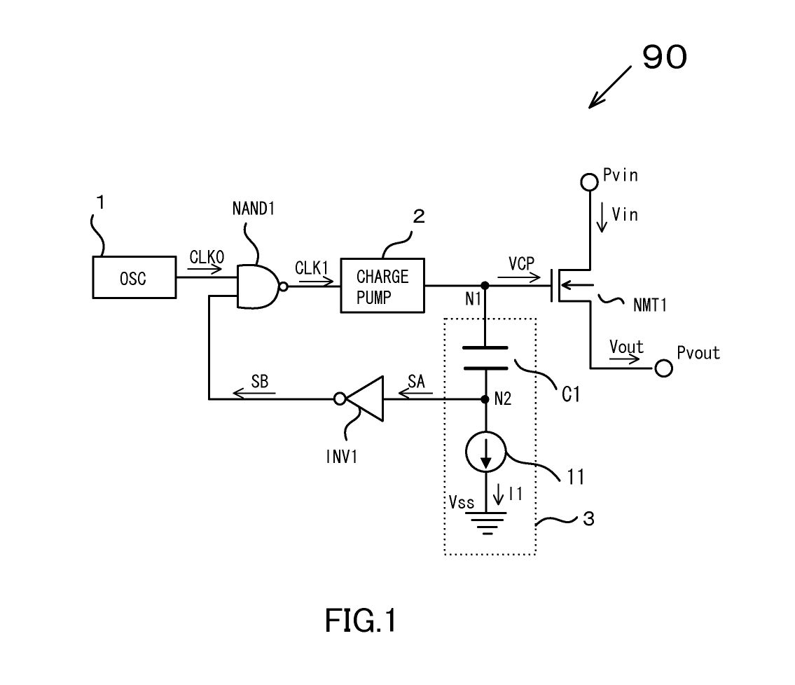

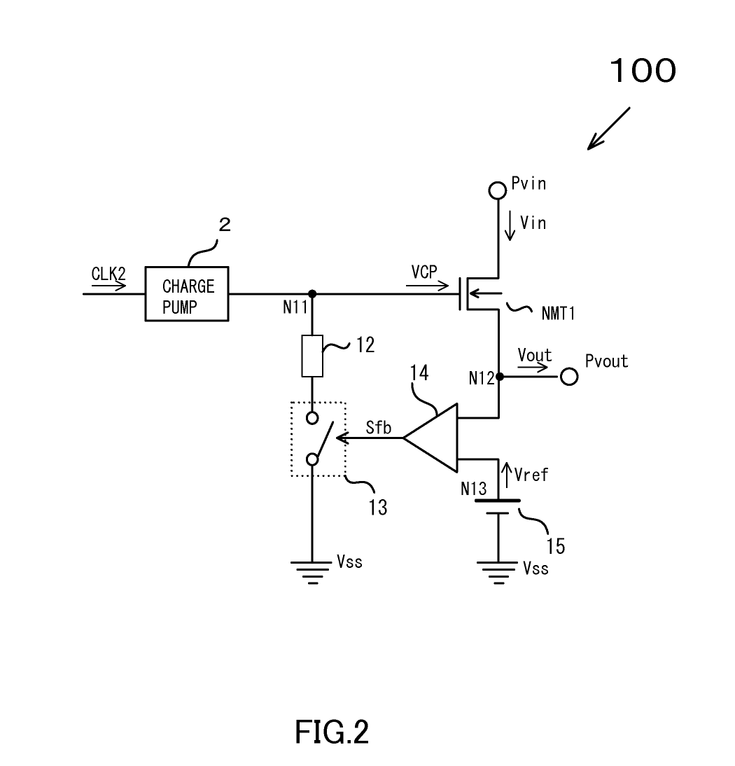

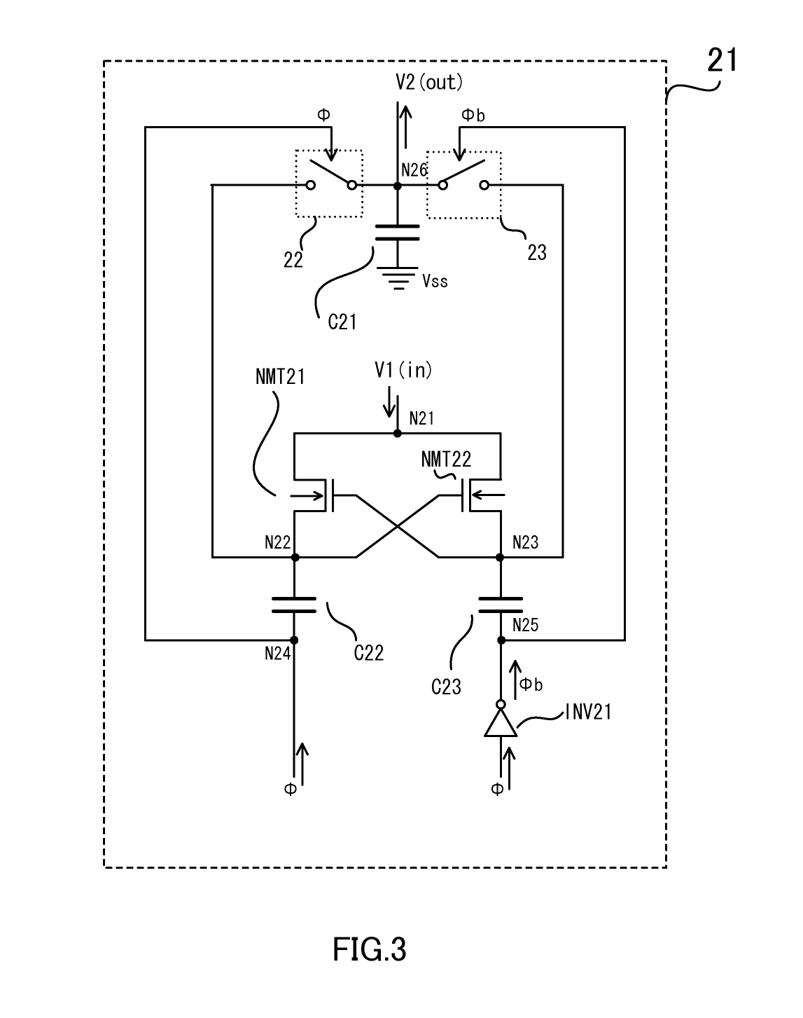

A switch circuit according to a first embodiment will be described with reference to FIGS. 1 to 3. FIG. 1 is a circuit diagram illustrating the switch circuit. FIG. 2 is a circuit diagram illustrating a switch circuit according to a comparative example. FIG. 3 is a circuit diagram illustrating a basic charge pump cell constituting a charge pump circuit.

In the embodiment, a soft start of the switch circuit is implemented by using a high pass filter and an inverter.

As illustrated in FIG. 1, the switch circuit 90 includes an oscillation circuit 1, a charge pump circuit 2, a high pass filter 3, a 2-input NAND circuit NAND1, an inverter INV1, an output transistor NMT1, an input voltage terminal Pvin, and an output voltage terminal Pvout. The switch circuit 90 is a gate boost type switch circuit. The soft start of the switch circuit 90 is implemented by using the high pass filter 3 and the inverter INV1.

The switch circuit 90 is applied to a mobile terminal, a digital camera, a game machine, a notebook PC, a portable AV apparatus, and the like. In comparison with an LDO (Low Drop Out), or the like, the switch circuit can respond to a load ranging from a light load to a heavy load and can be driven with a low voltage.

The oscillation circuit 1 generates a clock signal CLCK0 (reference clock signal) with a square wave. The first input side of the 2-input NAND circuit NAND1 receives the clock signal CLCK0, and the second input side of the 2-input NAND circuit NAND1 receives a first signal SB. The 2-input NAND circuit NAND1 outputs a clock signal CLK1 (first clock signal) which is logic-operation-processed through the output side. The clock signal CLK1 performs an intermittent operation by the clock signal CLCK0 and the first signal SB.

The charge pump circuit 2 is provided between the 2-input NAND circuit NAND1 and a node N1. The charge pump circuit 2 boosts a first voltage V1 (in) based on the clock signal CLK1 to output a charge pump voltage VCP through the output side (node N1). The internal configuration of the charge pump circuit 2 and the first voltage V1 (in) will be described later in detail.

The output transistor NMT1 is an N-channel MOS transistor. The output transistor NMT1 has one terminal (drain) to which an input voltage Vin is input through an input voltage terminal Pvin, the control terminal (gate) receives the charge pump voltage VCP, and the other terminal (source) is connected to an output voltage terminal Pvout. The output transistor NMT1 operates based on the charge pump voltage VCP to output the output voltage Vout through the other terminal (source) side.

The one terminal of the high pass filter 3 receives the charge pump voltage VCP, the high pass filter 3 has the other terminal to which a ground voltage Vss is applied. The high pass filter 3 attenuates a frequency component which is lower than a predetermined frequency of the charge pump voltage VCP to output a second signal SA through a node N2. The high pass filter 3 includes a capacitor C1 and a current source 11.

The capacitor C1 has the one terminal connected to the node N1 and the other terminal connected to the node N2. The current source 11 has one terminal connected to the node N2, and the other terminal to which the ground voltage Vss is applied. A current I1 is allowed to flow from the node N2 side to the ground voltage Vss.

The inverter INV1 is provided between the node N2 and the 2-input NAND circuit NAND1. The inverter INV1 receives the second signal SA and inverts the second signal SA to obtain the first signal SB to output the first signal SB to the second input side of the 2-input NAND circuit NAND1.

As illustrated in FIG. 2, the switch circuit 100 according to the comparative example includes a charge pump circuit 2, a load 12, a switch 13, a comparator 14, a reference voltage generating circuit 15, an output transistor NMT1, an input voltage terminal Pvin, and an output voltage terminal Pvout.

The charge pump circuit 2 boosts a first voltage V1 (in) based on a clock signal CLK2 to output a charge pump voltage VCP through the output side (node N11).

The output transistor NMT1 has one terminal (drain) to which an input voltage Vin is input through the input voltage terminal Pvin, the control terminal (gate) of the output transistor NMT1 receives a charge pump voltage VCP, and the other terminal (source) of the output transistor NMT1 is connected to the output voltage terminal Pvout. The output transistor NMT1 operates based on the charge pump voltage VCP to output an output voltage Vout through the other terminal (source) side (node N12 side).

The reference voltage generating circuit 15 is provided between a node N13 and a ground voltage Vss to generate a reference voltage Vref. The comparator 14 has a first input side (node N12 side) to which the output voltage Vout is input and the second input side (node N13 side) to which the reference voltage Vref is input, and generates a compared and amplified signal Sfb.

The load 12 has one terminal connected to the node N11. The switch 13 has one terminal connected to the other terminal of the load 12, the switch 13 has the other terminal to which the ground voltage Vss is applied; and the switch 13 is turned on or off based on the signal Sfb.

The switch circuit 100 according to the comparative example monitors the output voltage Vout to switch the load of the charge pump circuit 2. In a case in which the output voltage Vout is lower than the reference voltage Vref, at the startup time, the switch circuit 100 according to the comparative example turns on the switch 13 to connect the load 12 to the ground voltage Vss. As a result, the starting of the charge pump circuit 2 is delayed, and thus the soft start is implemented.

However, in the switch circuit 100 according to the comparative example, since the reference voltage generating circuit 15 generating the reference voltage Vref, the comparator 14, and the like are required, the circuit configuration is complicated in comparison with the embodiment. In addition, since the output transistor NMT1, the comparator 14, and the reference voltage generating circuit 15 are connected in series between the input voltage terminal Pvin and the ground voltage Vss, the switch circuit 100 has a difficulty in operating at a low input voltage equal to or less than 1V, for example.

On the contrary, in the switch circuit 90, since the comparator 14, the reference voltage generating circuit 15, and the like which are connected in series are not provided between the output voltage terminal Pout and the ground voltage Vss, the switch circuit 90 can operate at a low input voltage.

As illustrated in FIG. 3, in the charge pump circuit 2, the basic charge pump cell 21 has a multi-stage configuration, for example. The charge pump circuit 2 boosts the first voltage V1 (in) based on the clock signal CLK1 to generate the charge pump voltage VCP. The basic charge pump cell 21 is a cross-coupled type charge pump circuit. The number of stages of the basic charge pump cell 21 is appropriately set according to a magnitude of the charge pump voltage VCP.

More specifically, the basic charge pump cell 21 includes a switch 22, a switch 23, capacitors C21 to C23, an inverter INV21, an N-channel MOS transistor NMT21, and an N-channel MOS transistor NMT22. A node N21 of the basic charge pump cell 21 receives the first voltage V1 (in), and the basic charge pump cell 21 outputs the voltage V2 (out) through a node N26.

The N-channel MOS transistor NMT21 and the N-channel MOS transistor NMT22 are connected in a cross-coupled manner. The N-channel MOS transistor NMT21 has a drain to which the first voltage V1 (in) is input, the gate connected to a node N23, and the source connected to a node N22. The N-channel MOS transistor NMT22 has a drain to which the first voltage V1 (in) is input, the gate connected to the node N22, and the source connected to the node N23. The capacitor C22 has one terminal connected to the node N22, and the other terminal to which a clock signal φ (corresponding to the clock signal CLK1 illustrated in FIG. 1 and the clock signal CLK2 illustrated in FIG. 2) is input. The capacitor C23 has one terminal connected to the node N23, and the other terminal which receives a clock signal φb which is obtained by the inverter INV21 inverting the clock signal φ.

The capacitor C21 has one terminal connected to the node N26, and the other terminal to which the ground voltage Vss is applied. The switch 22 has one terminal connected to the node N22 and the other terminal connected to the node N26, and connects the node N22 and the node N26 based on the clock signal φ. The switch 23 has one terminal connected to the node N23 and the other terminal connected to the node N26, and connects between the node N23 and the node N26 based on the clock signal φb.

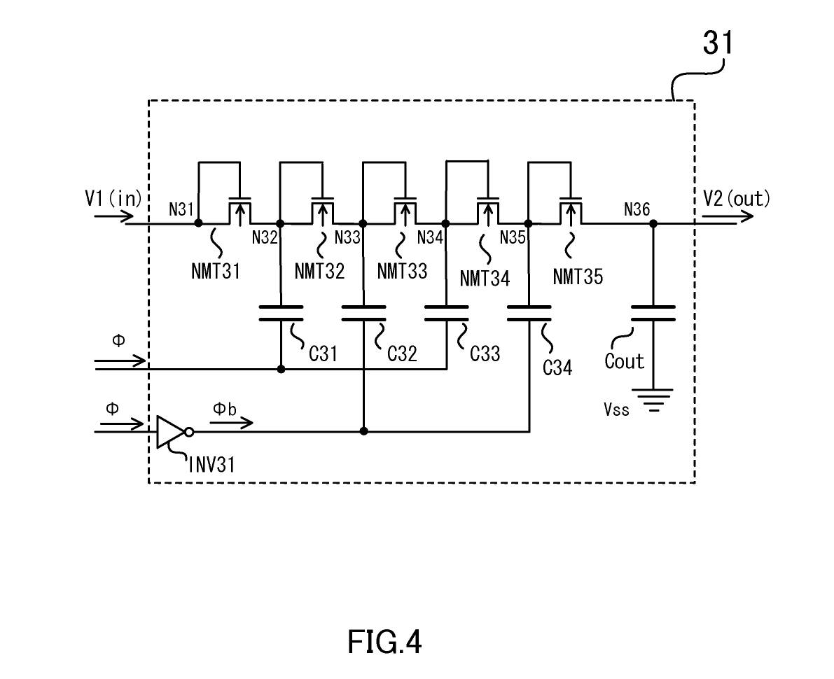

Herein, the cross-coupled type charge pump circuit is used for charge pump circuit 2. However, the charge pump circuit 2 is not limited thereto. For example, a Dickson type charge pump circuit 31 illustrated in FIG. 4 may be used.

More specifically, the charge pump circuit 31 includes capacitors C31 to C34, a capacitor Cout, an inverter INV31, and N-channel MOS transistors NMT31 to NMT35. The charge pump circuit 31 is a Dickson type charge pump circuit having a 4-stage configuration.

The N-channel MOS transistors NMT31 to NMT35 which are connected with diodes and are connected in series are provided between the node N31 (first voltage V1 (in) side) and the node N36 (voltage V2 (out) side). The clock signal φ is input to the gate of the N-channel MOS transistor NMT32 through the capacitor C31 and the node N32, and the clock signal φ is input to the gate of the N-channel MOS transistor NMT34 through the capacitor C33 and the node N34. The clock signal (kb is input to the gate of the N-channel MOS transistor NMT33 through the capacitor C32 and the node N33, and the clock signal φb is input to the gate of the N-channel MOS transistor NMT35 through the capacitor C34 and the node N35. The capacitor Cout has one terminal connected to the node N36, and the other terminal to which the ground voltage Vss is applied.

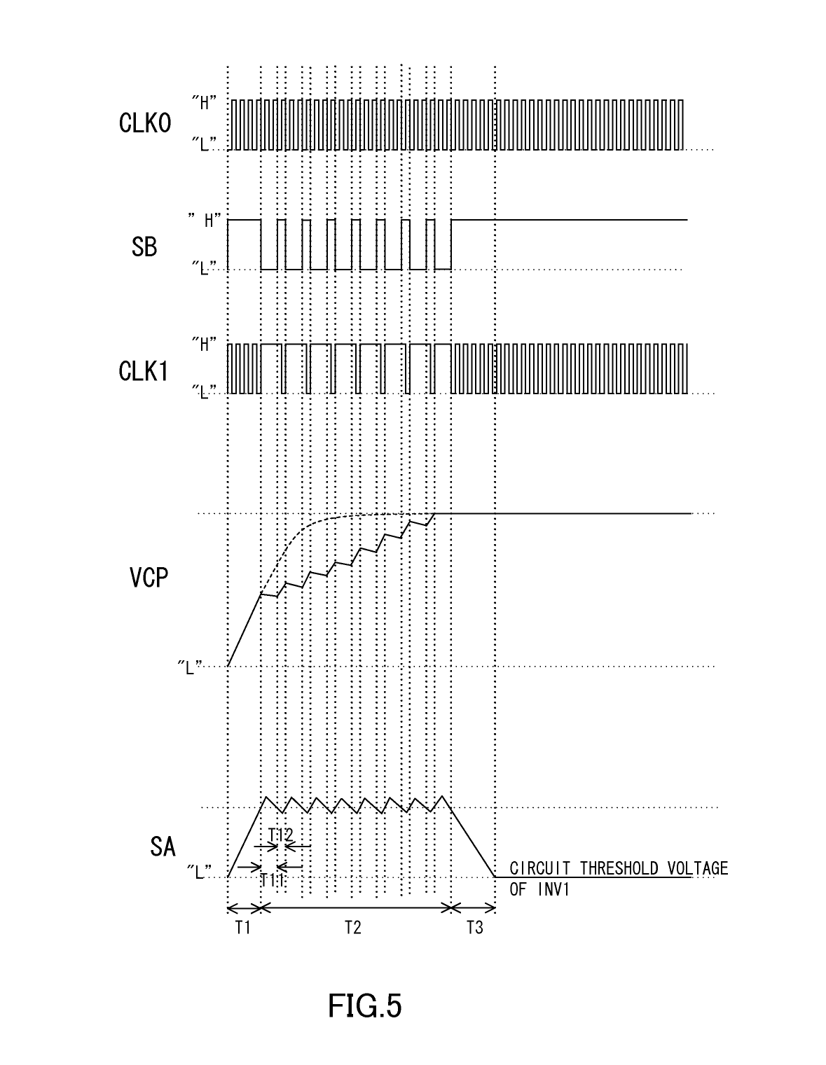

Next, operations of the switch circuit according to the embodiment will be described with reference to FIG. 5. FIG. 5 is a timing chart illustrating the operations of the switch circuit.

As illustrated in FIG. 5, in the switch circuit 90 according to the embodiment, when the power and the input voltage Vin are supplied and the oscillation circuit 1 starts operations, the 2-input NAND circuit NAND1 receives the clock signal CLCK0 (reference clock signal) and the first signal SB as a feedback input from the inverter INV1, and thereby the clock signal CLCK1 (first clock signal) is generated. The charge pump circuit 2 starts operations based on the clock signal CLCK1 (first clock signal).

After starting the operations, in the time period T1, the second signal SA (node N2) has a value which is equal to or smaller than the circuit threshold value of the inverter INV1, and the clock signal CLCK1 becomes a signal substantially equal to the clock signal CLCK0 (herein, a circuit delayed amount not regarding to the 2-input NAND circuit NAND1).

The charge pump voltage VCP continues to be boosted, and after the time period T1, the second signal SA (node N2) has a value which is equal to or larger than the circuit threshold value of the inverter INV1, and thereby the first signal SB is in the “Low” level. As a result, the clock signal CLCK1 is fixed at the “High” level during the time period T11, and the charge pump circuit 2 stops the operations, and thereby the charge pump voltage VCP is dropped. The voltage drop time is determined based on the capacitance of the capacitor C1 of the high pass filter 3 and the current I1 of the current source 11.

When the charge pump voltage VCP is dropped, the second signal SA is equal to or smaller than the circuit threshold value of the inverter INV1, and thereby the first signal SB is in the “High” level. As a result, since the clock signal CLCK1 is changed from the “High” level to the “Low” level during the time period T12, the charge pump circuit 2 operates, and thereby the charge pump voltage VCP is boosted.

The operation in the time period T11 and the operation in the time period T12 are repeated, and thereby the charge pump voltage VCP is gradually boosted, and after the time period T2, a predetermined charge pump voltage VCP is obtained. As a result, the soft start is implemented. After the time period T2, the second signal SA is equal to or smaller than the circuit threshold value of the inverter INV1. After the time period T3, the second signal SA is in the “Low” level, and the first signal SB maintains the “High” level.

Due to the soft start, it is possible to greatly suppress the rush current. Therefore, malfunction of the power management integrated circuit can be suppressed, and a current allowable value of a wire line or the like is not exceeded, so that it is possible to prevent the power management integrated circuit or the wire line from being destructed.

Herein, for example, in a switch circuit which does not include a high pass filter and the like are not provided and does not perform the soft start operation, when the rising edge of the charge pump voltage VCP is denoted by SR11 (V/Sec.) and the frequency of the clock signal CLK0 is denoted by f, the rising edge of the charge pump voltage VCP in one pulse can be denoted by SR11/f (V).

In the switch circuit 90 which performs the soft start operation according to the embodiment, when the rising edge of the charge pump voltage VCP is denoted by SR1 (V/Sec.), the capacitance of the capacitor C1 is denoted by c1, and the current flowing through the current source 11 is denoted by current I1, the rising edge SRI of the charge pump voltage VCP can be expressed as follows.

SR1=(SR0/f/[(1/f)+{c1×(SR0/f)}/I1] Equation (1)

SR1=1/{(1/SR0)+(c1/I1)} Equation (2)

The rising edge of the charge pump voltage VCP can be adjusted by setting the capacitance c1 and the current I1 to appropriate values. In addition, when the rising edge SR11 of the charge pump voltage VCP is set to be much larger than (I1/c1), the rising edge SR1 of the charge pump voltage VCP can be approximated to (I1/c1).

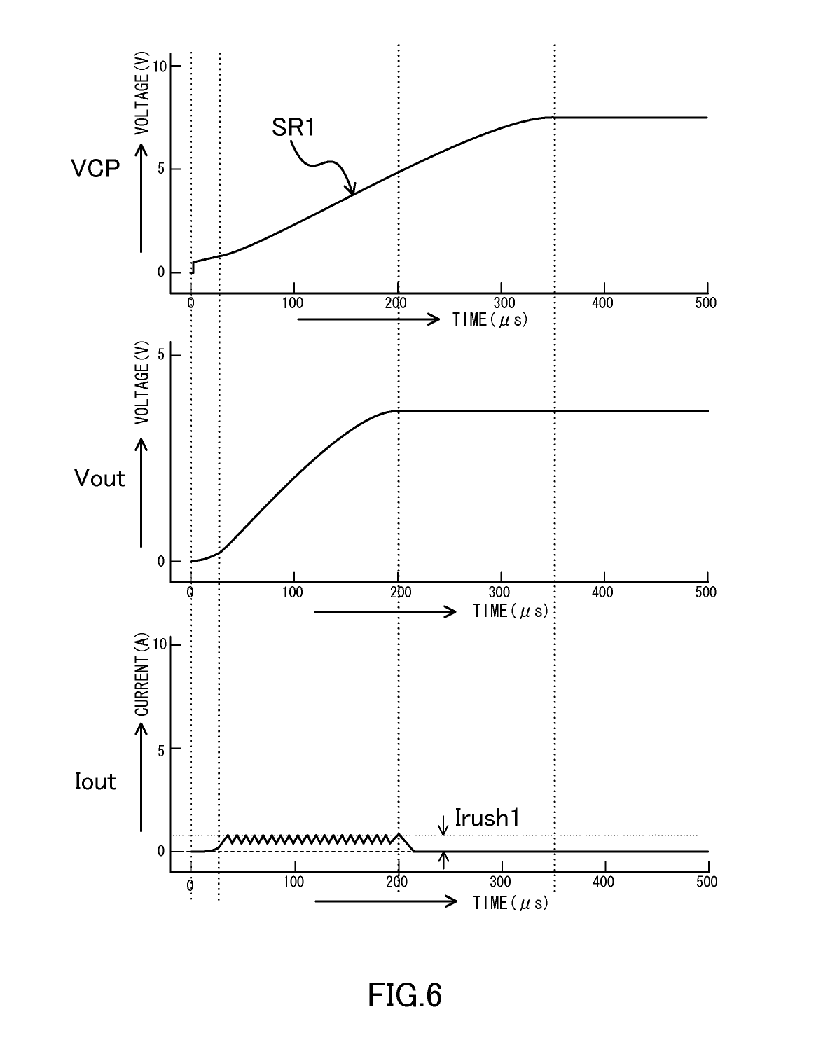

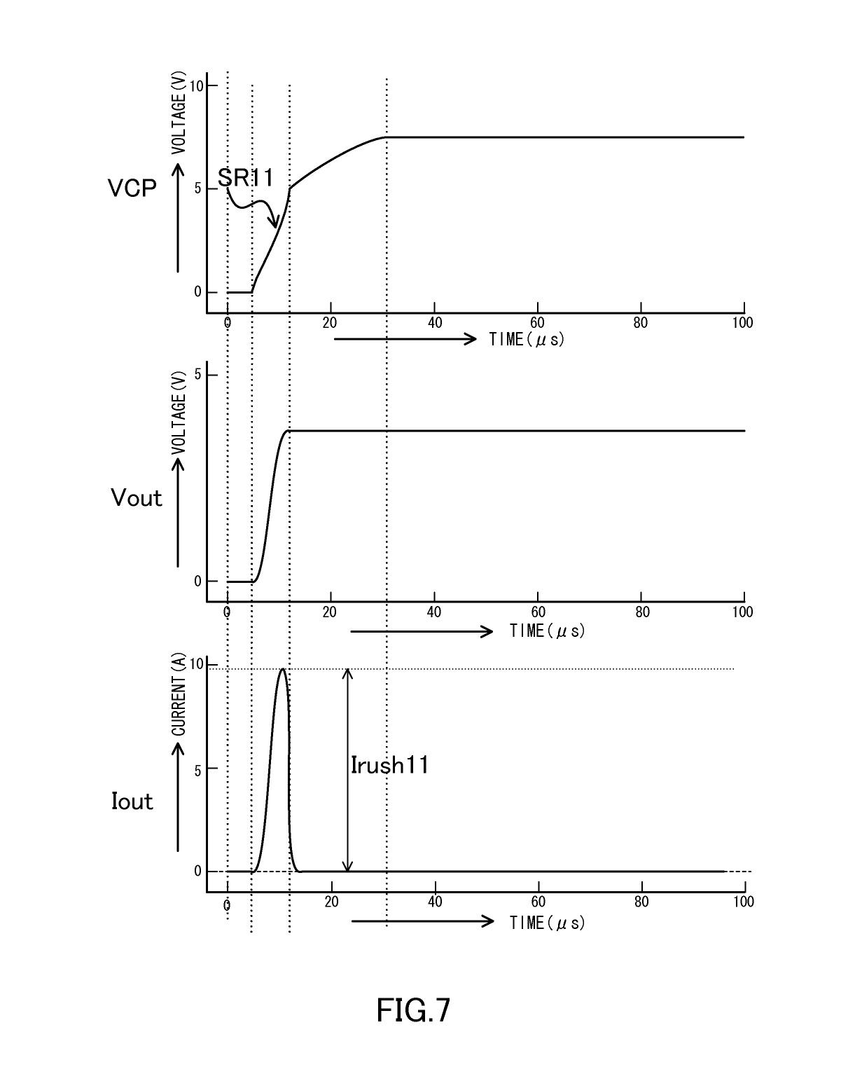

Next, a rush current occurring in a switch circuit will be described with reference to FIGS. 6 and 7. FIG. 6 is a diagram illustrating a rush current occurring in the switch circuit according to the first embodiment. FIG. 7 is a diagram illustrating a rush current occurring in the switch circuit which does not perform the soft start operation according to the first embodiment. Simulation waveforms illustrated in FIGS. 6 and 7 are waveforms of the case where the input voltage Vin is 3.6 V, the frequency of the clock signal CLK0 is 5 MHz, and the load capacitance is 47 μF.

As illustrated in FIG. 6, in the switch circuit 90 according to the embodiment, after 350 μs from the time of starting the operation, a predetermined charge pump voltage VCP is obtained. The rising edge SR1 of the charge pump voltage VCP becomes 20 kV/sec. The rush current Irush1 occurs in a time interval from 20 μs to 210 μs after the starting of the operation. However, due to the soft start operation, the current level is greatly suppressed.

As illustrated in FIG. 7, in the switch circuit which does not perform the soft start operation, after 5 us from the time of starting the operation, the boosting of the charge pump voltage VCP is started, and the rising edge of the charge pump voltage VCP is maintained almost constant up to 14 μs. In the time period, the rising edge SR11 of the charge pump voltage VCP is 730 kV/sec which is 36 times faster than that of the embodiment. As a result, the rush current Irush11 is 10 or more times larger than that of the embodiment, so that a large current flows in a short time (approaching the maximum rush current Irush11 in 13 μs).

As described above, the switch circuit according to the embodiment is configured to include the oscillation circuit 1, the charge pump circuit 2, the high pass filter 3, the 2-input NAND circuit NAND1, the inverter INV1, the output transistor NMT1, the input voltage terminal Pvin, and the output voltage terminal Pvout. The high pass filter 3 includes the capacitor C1 and the current source 11. The high pass filter 3 has one terminal to which the charge pump voltage VCP is input, and the other terminal to which the ground voltage Vss is applied. The high pass filter 3 attenuates the frequency component which is lower than a predetermined frequency of the charge pump voltage VCP to output the second signal SA through the node N2. The inverter INV1 receives the second signal SA and inverts the second signal SA to obtain the first signal SB to output the first signal SB to the second input side of the 2-input NAND circuit NAND1. The output transistor NMT1 has a drain in which the input voltage Vin is input through the input voltage terminal Pvin, the gate of the output transistor NMT1 receives the charge pump voltage VCP, and the source of the output transistor NMT1 is connected to the output voltage terminal Pvout. The output transistor NMT1 outputs the output voltage Vout through the source side.

Therefore, in the switch circuit 90, it is possible to implement the soft start with the rush current being suppressed by using the high pass filter 3 and the inverter INV1. Since the comparator 14 or the reference voltage generating circuit 15 is not required to be provided, the size of the circuit can be reduced, and current consumption can be reduced. In addition, since the comparator 14, the reference voltage generating circuit 15 and the like which are connected in series are not provided, the switch circuit can operate at a low input voltage.

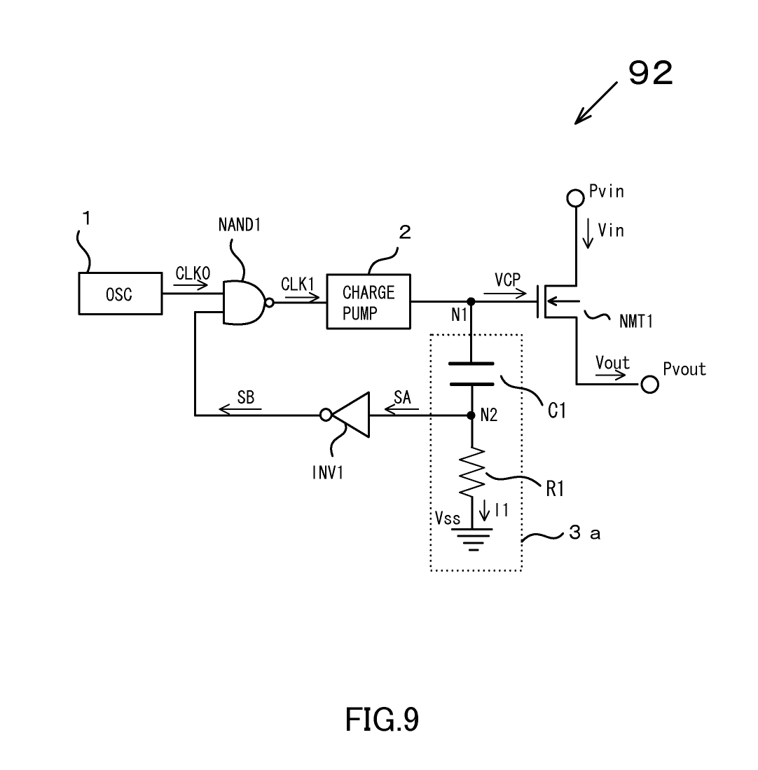

In addition, in the embodiment, the high pass filter 3 includes the capacitor C1 and the current source 11. However, the high pass filter 3 is not limited to the above configuration. For example, the configuration of the high pass filter 3a of the switch circuit 92 illustrated in FIG. 9 may be used. More specifically, the high pass filter 3a includes a capacitor C1 and a resistor R1. The capacitor C1 has one terminal connected to a node N1 and the other terminal connected to a node N2. The resistor R1 has one terminal connected to the node N2 and the other terminal connected to the ground voltage Vss.

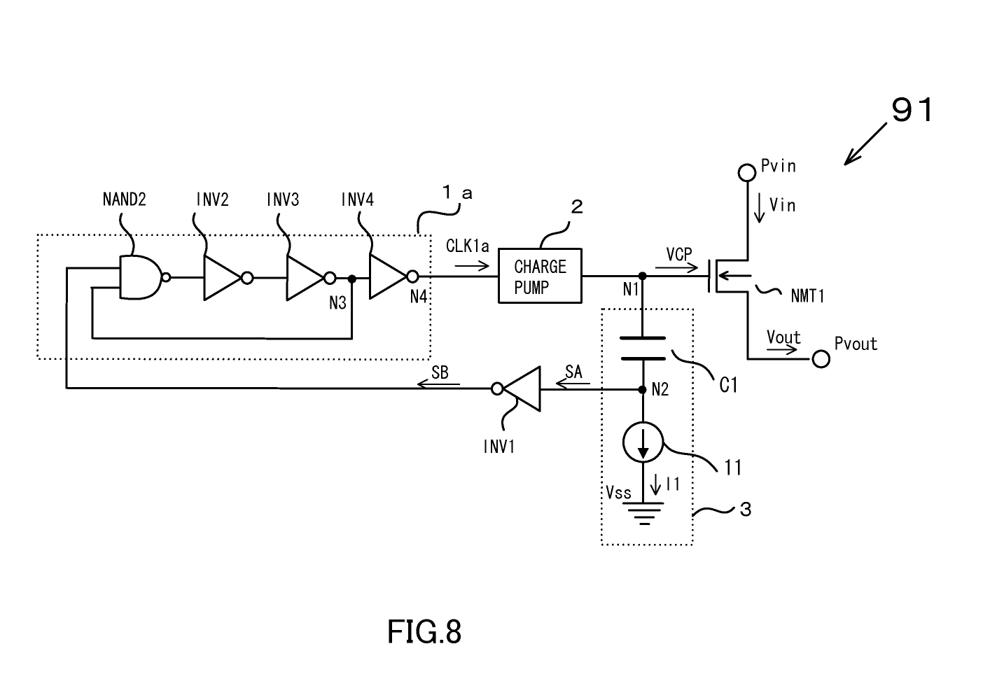

A switch circuit according to a second embodiment will be described with reference to the drawings. FIG. 8 is a circuit diagram illustrating the switch circuit.

In the embodiment, soft start of the switch circuit is implemented by using a high pass filter and an inverter instead of the 2-input NAND circuit NAND1 of the first embodiment.

Hereinafter, the same components of the configuration of the first embodiment are denoted by the same reference numerals, and the description thereof is omitted. Only the different components will be described.

As illustrated in FIG. 8, a switch circuit 91 includes an oscillation circuit 1a, a charge pump circuit 2, a high pass filter 3, an inverter INV1, an output transistor NMT1, an input voltage terminal Pvin, and an output voltage terminal Pvout. The switch circuit 91 is a gate boost type switch circuit. The switch circuit 91 is applied to a mobile terminal, a digital camera, a game machine, a notebook PC, a portable AV apparatus, and the like.

The oscillation circuit 1a includes a 2-input NAND circuit NAND2 and inverters INV2 to INV4. The 2-input NAND circuit NAND2 and the inverters INV2 to INV4 are connected in series. Unlike the oscillation circuit 1 according to the first embodiment, the oscillation circuit 1a can stop itself so as to perform an intermittent operation.

The 2-input NAND circuit NAND2 has a first input side in which a first signal SB is input, and the second input side connected to a node N3 (input side of the inverter INV4). The 2-input NAND circuit NAND2 outputs a signal which is logical-operation-processed. The inverter INV2 inverts the output of the 2-input NAND circuit NAND2. The inverter INV3 inverts the output of the inverter INV2 and outputs the inverted signal through the node N3. The inverter INV4 inverts the signal of the node N3 and outputs the inverted signal as clock signal CLKa through a node N4.

Herein, the 2-input NAND circuit NAND2 is used for the oscillation circuit 1a. However, other logic circuits or the like may be appropriately used.

As described above, the switch circuit according to the embodiment includes the oscillation circuit 1a, the charge pump circuit 2, the high pass filter 3, the inverter INV1, the output transistor NMT1, the input voltage terminal Pvin, and the output voltage terminal Pvout. The oscillation circuit 1a includes the 2-input NAND circuit NAND2 and inverters INV2 to INV4 which are connected in series.

Therefore, in addition to the effects of the first embodiment, it is possible to obtain the effect in which the oscillation circuit 1a can stop itself.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A switch circuit comprising:
an output transistor including a first end to which an input voltage is input, a second end from which an output voltage is output, and a control terminal;
a charge pump circuit configured to receive a first clock signal based on both of a reference clock signal and a first signal, and output a charge pump voltage to the control terminal of the output transistor, the first signal being based on the charge pump voltage; and
a high pass filter including a first end receiving the charge pump voltage and a second end to which a ground voltage is applied, and configured to generate a second signal.

2. The switch circuit according to claim 1, wherein
the high pass filter is configured to attenuate a frequency component of the charge pump voltage, and generate the second signal so as to be lower than a predetermined frequency of the charge pump voltage.

3. The switch circuit according to claim 1, further comprising:
a first inverter;
an oscillation circuit; and
a 2-input NAND circuit,
wherein the first inverter is configured to invert the second signal to the first signal,
the oscillation circuit is configured to generate the reference clock signal, and
the 2-input NAND circuit has a first input side receiving the reference clock signal and a second input side to which the first signal is input, and outputs the first clock signal which is logical-operation-processed.

4. The switch circuit according to claim 1, wherein,
when a voltage level of the second signal exceeds a circuit threshold value voltage of the first inverter, the first signal is in a “Low” level and the charge pump circuit stops the boosting operation, and
when the voltage level of the second signal is lowered than the circuit threshold value voltage of the first inverter, the first signal is in a “High” level and the charge pump circuit performs the boosting operation.

5. The switch circuit according to claim 1, wherein
the high pass filter includes a first capacitor and a first current source,
the first capacitor has a first end to which the charge pump voltage is input, and a second end from which the second signal is output, and
the first current source has a first end connected to the second end of the first capacitor, and a second end to which the ground voltage is applied.

6. The switch circuit according to claim 1, wherein
the high pass filter includes a first capacitor and a first resistor,
the first capacitor has a first end receiving the charge pump voltage, and a second end from which the second signal is output, and
the first resistor has a first end connected to the second end of the first capacitor, and a second end to which the ground voltage is applied.

7. The switch circuit according to claim 1, wherein
the output transistor is an N-channel MOS transistor.

8. The switch circuit according to claim 1, wherein
the charge pump circuit is a cross-coupled type charge pump circuit or a Dickson type charge pump circuit.

9. The switch circuit according to claim 1, wherein
the switch circuit is a gate boost type switch circuit.

10. The switch circuit according to claim 1, wherein
the switch circuit is applied to a mobile device, a digital camera, a game machine, a notebook PC, and a portable AV apparatus.

11. A switch circuit comprising:
an output transistor including a first end to which an input voltage is input, a second end from which an output voltage is output, and a control terminal;
an oscillation circuit configured to receive a first signal, and generate a first clock signal;
a charge pump circuit configured to receive the first clock signal, and output a charge pump voltage to the control terminal of the output transistor;
a high pass filter including a first end receiving the charge pump voltage and a second end to which a ground voltage is applied, and configured to generate a second signal; and
a first inverter configured to invert the second signal to the first signal, and output the first signal to an input side of the oscillation circuit.

12. The switch circuit according to claim 11, wherein
the high pass filter is configured to attenuate a frequency component of the charge pump voltage, and generate the second signal so as to be lower than a predetermined frequency of the charge pump voltage.

13. The switch circuit according to claim 11, wherein
the oscillation circuit includes a 2-input NAND circuit and n inverters which are connected in series (where n is an odd number of 3 or more),
the 2-input NAND circuit has a first input side receiving the first signal, and a second input side which is connected to an input side of the n-th inverter, and
the first clock signal is output from the n-th inverter.

14. The switch circuit according to claim 11, wherein,
when a voltage level of the second signal exceeds a circuit threshold value voltage of the first inverter, the first signal is in a “Low” level, and the charge pump circuit stops the boosting operation, and
when the voltage level of the second signal is lowered than the circuit threshold value voltage of the first inverter, the first signal is in a “High” level, and the charge pump circuit performs the boosting operation.

15. The switch circuit according to claim 11, wherein
the high pass filter includes a first capacitor and a first current source,
the first capacitor has a first end to which the charge pump voltage is input, and a second end from which the second signal is output, and
the first current source has a first end connected to the second end of the first capacitor, and a second end to which the ground voltage is applied.

16. The switch circuit according to claim 11, wherein
the high pass filter includes a first capacitor and a first resistor,
the first capacitor has a first end receiving the charge pump voltage, and a second end from which the second signal is output, and
the first resistor has a first end connected to the second end of the first capacitor, and a second end to which the ground voltage is applied.

17. The switch circuit according to claim 11, wherein
the output transistor is an N-channel MOS transistor.

18. The switch circuit according to claim 11, wherein
charge pump circuit is a cross-coupled type charge pump circuit or a Dickson type charge pump circuit.

19. The switch circuit according to claim 11, wherein
the switch circuit is a gate boost type switch circuit.

20. The switch circuit according to claim 11, wherein
the switch circuit is applied to a mobile device, a digital camera, a game machine, a notebook PC, and a portable AV apparatus.
